(19) United States
(12) Patent Application Publication
(10) Pub. No.: US 2026/0353228 A1
(43) Pub. Date: Nov. 5, 2026

(54) SEAMLESS ROAMING ACROSS ACCESS POINT (AP) MULTI-LINK DEVICES (MLDS) WITH DIFFERENT SERVICE SET IDENTIFIERS (SSIDS)

(71) Applicant: Cisco Technology, Inc., San Jose, CA (US)

(72) Inventors: Binita Gupta, San Diego, CA (US); Brian D. Hart, Sunnyvale, CA (US)

(21) Appl. No.: 19/666,515

(22) Filed: May 4, 2026

Related U.S. Application Data
(60) Provisional application No. 63/800,214, filed on May 5, 2025.

(51) Int. Cl. H04W 36/18; H04W 12/041; H04W 12/06; H04W 12/60; H04W 88/10

(52) U.S. Cl. CPC H04W 36/18; H04W 12/041; H04W 12/06; H04W 12/60; H04W 88/10

(57) ABSTRACT

Seamless roaming across Access Point (AP) Multi-Link Devices (MLDs) in different Service Set Identifiers (SSIDs) may be provided. A backhaul network connection may be created between a first AP MLD having a first Service Set Identifier (SSID) and a second AP MLD having a second SSID. An extended Seamless Mobility Domain (SMD) including the first AP MLD having the first SSID and the second AP MLD having the second SSID may be formed. Forming the extended SMD may include enabling the first AP MLD and the second AP MLD to exchange a security context over the backhaul network connection.

### RELATED APPLICATION

Under provisions of 35 U.S.C. § 119(e), Applicant claims the benefit of U.S. Provisional Application No. 63/800,214, filed May. 5, 2025, which is incorporated herein by reference.

### TECHNICAL FIELD

The present disclosure relates generally to seamless roaming across Access Point (AP) Multi-Link Devices (MLDs) with different Service Set Identifiers (SSIDs).

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various implementations of the present disclosure. In the drawings:

FIG. 1 is a block diagram of an operating environment for seamless roaming across Access Point (AP) Multi-Link Devices (MLDs) with different Service Set Identifiers (SSIDs);

FIG. 2 is a flow chart of a method for seamless roaming across AP MLDs with different SSIDs; and

FIG. 3 is a block diagram of a computing device.

### DETAILED DESCRIPTION

### Overview

Seamless roaming across Access Point (AP) Multi-Link Devices (MLDs) in different Service Set Identifiers (SSIDs) may be provided. A backhaul network connection may be created between a first AP MLD having a first Service Set Identifier (SSID) and a second AP MLD having a second SSID. An extended Seamless Mobility Domain (SMD) including the first AP MLD having the first SSID and the second AP MLD having the second SSID may be formed. Forming the extended SMD may include enabling the first AP MLD and the second AP MLD to exchange a security context over the backhaul network connection.

Both the foregoing overview and the following example implementations are examples and explanatory only and should not be considered to restrict the disclosure’s scope, as described and claimed. Furthermore, features and/or variations may be provided in addition to those described. For example, implementations of the disclosure may be directed to various feature combinations and sub-combinations described in the example implementations.

### Example Implementations

The following detailed description refers to the accompanying drawings. Wherever possible, the same reference numbers are used in the drawings and the following description to refer to the same or similar elements. While implementations of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Seamless roaming capability has been an area of interest for improving roaming quality within wireless networks. For instance, the next generation of the Institute of Electrical and Electronics Engineers (IEEE) 802.11bn (that is, Wi-Fi 8) may seek roaming enhancements to support more reliable and seamless roaming. To achieve seamless roaming, a roaming transition time and delays added due to roaming related operations may need to be reduced. In one example, to support seamless roaming, a non-Access Point (AP) Multi-Link Device (MLD) (for example, a Station (STA)) may create an association with a Seamless Mobility Domain (SMD) instead of with an individual AP MLD. Associating with an SMD may enable the non-AP MLD to roam seamlessly between member AP MLDs of the SMD without requiring reassociation and reestablishment of contexts with each new AP MLD. That is, associating with an SMD may ensure that when the non-AP MLD moves from the current AP MLD to a target AP MLD, the non-AP MLD may not need to perform reassociation. reestablishment of contexts and rekeying, and the non-AP MLD context may be transferred from the current AP MLD to the target AP MLD to achieve seamless roaming. In one example, rekeying may be performed in advance preparation done for seamless roaming. Thus, by enabling the non-AP MLD to associate with a SMD that includes multiple member AP MLDs may significantly reduce roaming time to realize seamless roaming (e.g., smooth and continuous roaming with no apparent interruption in data communication) and significantly improve a non-AP MLD’s wireless performance in terms of increased throughput, reduced latency, and higher range, as illustrative, non-limiting examples.

Seamless roaming may have two phases: a roaming preparation phase and a roaming execution phase. In the roaming preparation phase, the non-AP MLD prepares a target AP MLD in advance for roaming transition in near future. The roaming preparation phase may involve link setup, context transfer, and Quality-of-Service (QoS) related resource reservation on the target AP MLD. In some examples, the roaming preparation phase may also involve setting up new keying material for the target AP (for example, a new Per-AP Pairwise Transient Key (PTK)) and transfer of estimated values for dynamic context such as a Sequence Number (SN) and Packet Number (PN). Once a non-AP MLD has performed the roaming preparation with a target AP MLD, it then may perform the roaming execution to that target AP MLD to roam to that target AP MLD. The roaming execution phase may involve the latest dynamic context transfer (such as transfer of latest PN) and changing a Distribution System (DS) mapping for the non-AP MLD from the current AP MLD to the target AP MLD. That is, in an SMD, seamless roaming may be enabled through advanced roaming preparation (that is, setting up the links and transferring context for the non-AP MLD including shared security associations Pairwise Master Key Security Association (PMKSA) and Pairwise Transient Key Security Association (PTKSA) and data exchange context such as estimated SN, PN) and with further dynamic context transfer (such as the latest PN) during roaming execution to preserve data exchange context.

AP MLDs that are part of the same SMD may be considered part of the same Extended Service Set (ESS) or same Service Set Identifier (SSID), and common security associations (for example, a single SMD wide Pairwise Master Key Security Association (PMKSA) containing an SMD wide Pairwise Master Key (PMK) and a single SMD wide Pairwise Transient Key Security Association (PTKSA) containing an SMD wide PTK or per-AP MLD PTKs) may be established for the SMD that may be shared across AP MLDs of the SMD. Typically, AP MLDs that belong to different ESSs or SSIDs may not share security keys (that is, PMK or PTKs) due to security concerns. For example, two neighboring Wi-Fi networks in an enterprise (for example, a shopping mall) setting that are part of different SSIDs may not share security keys, hence seamless roaming may not be executed across such AP MLDs that are part of different SSIDs.

Embodiments of the disclosure may provide an extended SMD for seamless roaming that may include AP MLDs from multiple ESSs/SSIDs as members. The extended SMD may enable a non-AP MLD to roam from one AP MLD to another AP MLD within the extended SMD even when two AP MLDs belong to different SSIDs/ESSs.

The extended SMD may be used in settings (for example, in an enterprise, a residential, and other verticals) where different SSIDs may be managed by the same management entity or domain. For example, different SSIDs may be used to provide connectivity over different bands (2.4 GHz, 5 GHz, or 6 GHz SSIDs) in the same management domain across AP devices. In such settings, the AP MLDs that may belong to different SSIDs may be connected over a backhaul with a secure channel and may share security keys over the backhaul with each other.

In a first example implementation, in an enterprise deployment a physical AP device may host a first AP MLD with 2.4 GHz and 5 GHz links and a second AP MLD with 5.0 GHz and 6.0 GHz links on the same physical AP device. These AP MLDs may advertise different SSIDs and same set of SSIDs may be deployed across multiple physical AP devices in the network. Since all these SSIDs are hosted on the same physical AP device they are managed by the same management entity, and therefore these SSIDs may be enabled to exchange the security keys for seamless roaming.

In a second example implementation, a physical AP device may have three different SSIDs for three bands: a first SSID (for example, Ssid_1) for 2.4 GHz, a second SSID (for example, Ssid_2) for 5.0 GHz, and a third SSID (for example, Ssid_3) for 6.0 GHz. These three SSIDs may be deployed across multiple physical AP devices in the network. Since these SSIDs are hosted on the same physical AP device they are all managed by the same management entity, and therefore these SSIDs may be enabled to exchange the security keys for the seamless roaming.

In a third example implementation, in a commercial deployment (for example, a shopping mall), different AP MLDs in different stores may have different SSIDs but all these AP MLDs may be managed by a single management entity, and hence may be enabled to exchange the security keys for the seamless roaming across those AP MLDs.

In a fourth example implementation, a car while driving in an urban area may connect with different AP MLDs that have different SSIDs but the urban WLAN deployment may have a secure connectivity among those AP MLDs (for example, because these AP MLDs are managed by the same management entity or operator) to be able to share the security key material for the seamless roaming across those AP MLDs.

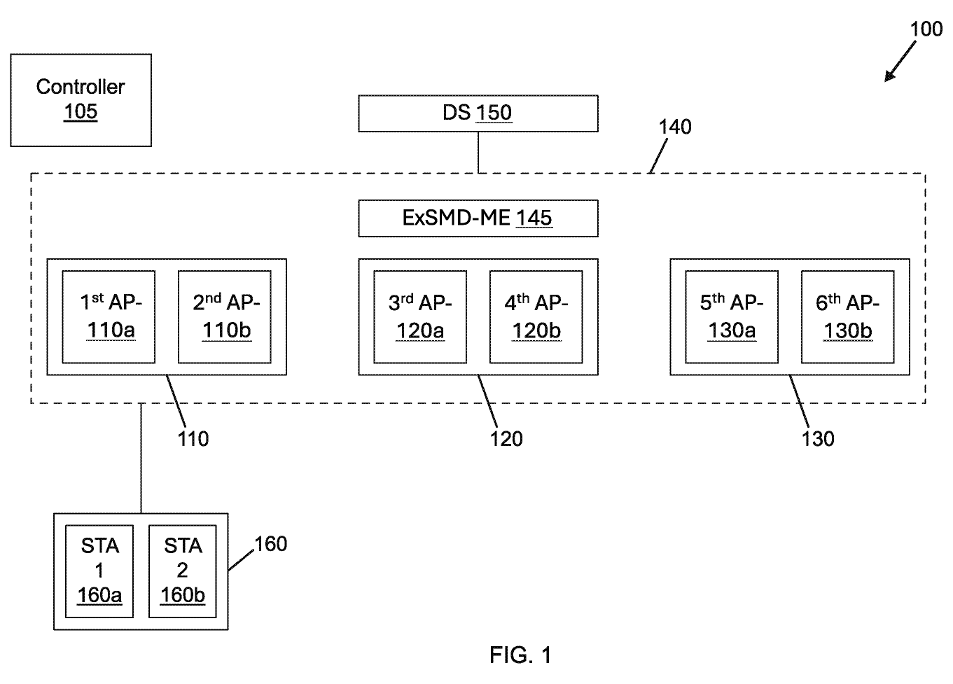

FIG. 1 is a block diagram of an operating environment 100 for seamless roaming across AP MLDs with different SSIDs. As shown in FIG. 1, operating environment 100 may comprise a controller 105, a plurality of AP MLDs, for example, a first AP MLD 110, a second AP MLD 120, and a third AP MLD 130. First AP MLD 110 may be associated with a first ESS (that is, ESS1) and a first SSID (for example, SSID1). Second AP MLD 120 may be associated with a second ESS (that is, ESS2) and a second SSID (for example, SSID2). Each of the plurality of AP MLDs may include one or more APs. For example, first AP MLD 110 may include a first AP 110a and a second AP 110b, second AP MLD 120 may include a third AP 120a and a fourth AP 120b, and third AP MLD 130 may include a fifth AP 130a and a sixth AP 130b.

Operating environment 100 may further include an extended SMD 140, an extended SMD Management Entity (ExSMD-ME) 145, a DS 150, and a non-AP MLD 160. Non-AP MLD 160 may include a first STA 160a and a second STA 160b. Extended SMD 140 may include a plurality of AP MLDs (that is, first AP MLD 110, second AP MLD 120, and third AP MLD 130) each with a Media Access Control (MAC)-Service Access Point (SAP) to DS 150.

ExSMD-ME 145 may enable converged architecture for the plurality of AP MLDs of extended SMD 140. ExSMD-ME 145 may enable seamless roaming across plurality of AP MLDs in extended SMD 140 which may belong to different SSIDs/ESSs. The extended SMD may enable non-AP MLD 160 to roam seamlessly between member AP MLDs which may belong to different SSIDs/ESSs without requiring reassociation and reestablishment of contexts with each new AP MLD. SMD ME 145 may be a logical entity and may be hosted on controller 105 or distributed on one or more of first AP MLD 110, second AP MLD 120, and third AP MLD 130. DS 150 may include wired ethernet or a wireless backhaul network used to connect multiple AP MLDs of extended SMD 140.

Extended SMD 140 may provide a coverage environment, for example, but is not limited to, a Wireless Local Area Network (WLAN) that may provide wireless network access (e.g., access to the WLAN for non-AP MLD 160 as it moves within the coverage environment). Non-AP MLD 160 may comprise, but are not limited to, a smart phone, a Head Mounted Device (HMD), a mice, a keyboard, a personal computer, a tablet device, a mobile device, a telephone, a remote control device, a set-top box, a digital video recorder, an Internet-of-Things (IoT) device, a network computer, a router, Augmented Reality (AR)/Virtual Reality (VR)/XR devices, or other similar microcomputer-based device.

Each of the plurality of APs may be compatible with specification standards such as, but not limited to, the IEEE 802.11 specification standard for example. The plurality of APs and STAs of operating environment 100 may use Multi-Link Operation (MLO) where they simultaneously transmit and receive across different bands and channels by establishing two or more links to two or more AP radios. These bands may comprise, but are not limited to the 2.4 GHz band, the 5 GHz band, the 6 GHz band, and the 60 GHz band.

Controller 105 may comprise a WLAN Controller (WLC) and may provision and control the coverage environment (for example, a WLAN). In some implementations of the disclosure, controller 105 may be implemented by a Digital Network Architecture Center (DNAC) controller (i.e., a Software-Defined Network (SDN) controller.

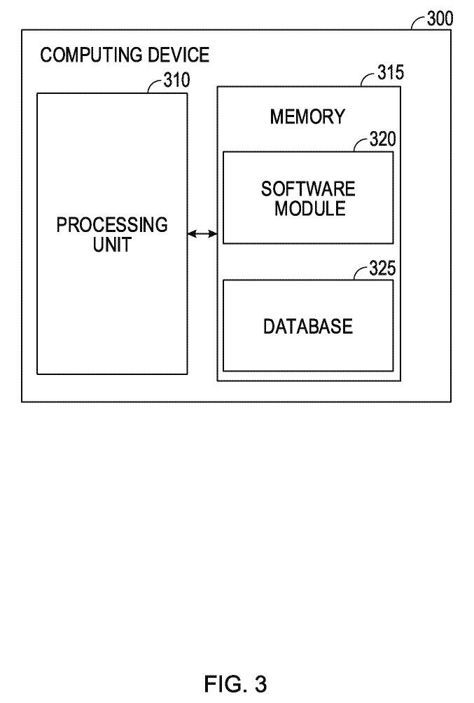

The elements described above of operating environment 100 (e.g., controller 105, first AP MLD 110, second AP MLD 120, third AP MLD 130, extended SMD 140, ExSMD ME 145, DS 150, and non-AP MLD 160) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

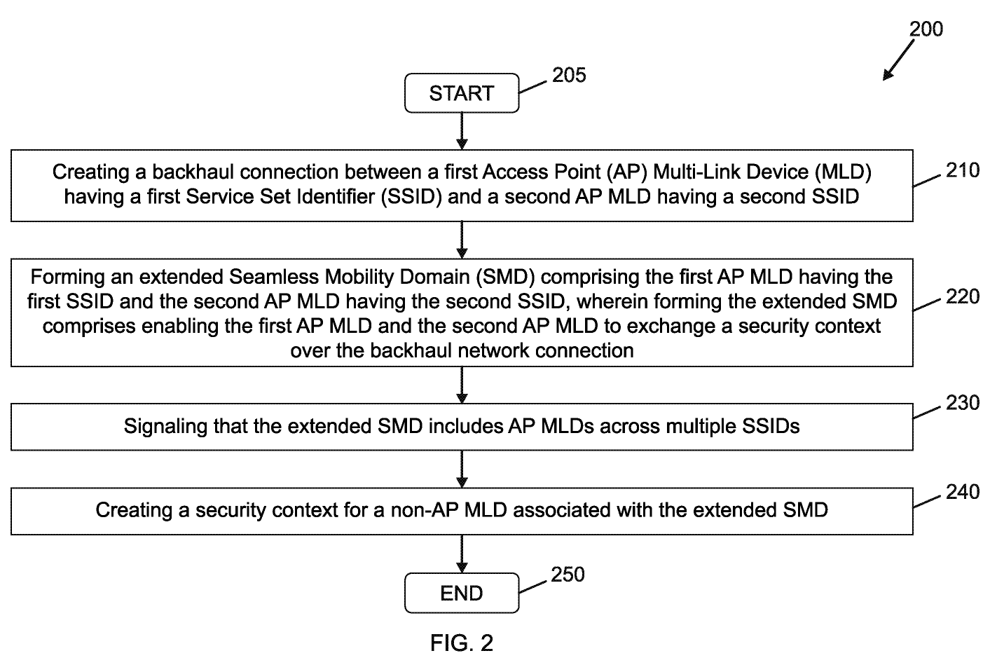

FIG. 2 is a flow chart setting forth the general stages involved in a method 200 consistent with implementations of the disclosure for seamless roaming across AP MLDs with different SSIDs. Method 200 may be implemented using controller 105 or any of member AP MLD (that is, first AP MLD 120, second AP MLD 120, or third AP MLD 130) of extended SMD 140 as described in more detail above with respect to FIG. 1. Ways to implement the stages of method 200 will be described in greater detail below.

Method 200 may begin at starting block 205 and proceed to stage 210 where controller 105 may create a backhaul network connection between first AP MLD 110 having a first SSID (that is, SSID1) and a second AP MLD 120 having a second SSID (that is, SSID2). The first SSID (that is, SSID1) may be different from the second SSID (that is, SSID2). In one example, first AP MLD 110 may be associated with a first ESS (that is, ESS1) and second AP MLD 120 may be associated with a second ESS (that is, ESS2). In addition, both first AP MLD 110 and second AP MLD 120 may be managed by the same management entity or domain. In such settings, both first AP MLD 110 and second AP MLD 120 may belong to different SSIDs/ESSs but may be connected over a backhaul network connection with a secure channel.

After creating the backhaul network connection between first AP MLD 110 having the first SSID and second AP MLD 120 having the second SSID at stage 210, method 200 may proceed to stage 220 where controller 105 may create an extended SMD 140 comprising first AP MLD 110 having the first SSID and second AP MLD 120 having the second SSID. Forming extended SMD 140 may include enabling first AP MLD 110 and second AP MLD 120 to exchange a security context (e.g. security keying material) over the backhaul network connection with the secure channel.

Once having created extended SMD 140 including first AP MLD 110 having the first SSID and second AP MLD 120 having the second SSID at stage 220, method 200 may proceed to stage 230 where controller 105 or ExSMD-ME 145 may signal via each AP MLD in the extended SMD 140 that extended SMD 140 includes AP MLDs across multiple SSIDs. In some examples, this signaling may provide a list of SSIDs (that is, SSID1 and SSID2) associated with member AP MLDs of extended SMD 140. This signaling may inform non-AP MLD 160 of presence of multiple SSIDs in extended SMD 140.

After signaling that extended SMD 140 includes AP MLDs across multiple SSIDs at stage 230, method 200 may proceed to stage 240 where controller 105 or ExSMD-ME 145 may create a security context for non-AP MLD 160 associated with extended SMD 140 (or associated with ExSMD-ME 145 in the extended SMD 140). The security context for non-AP MLD 160 may be shared across all AP MLDs in extended SMD 140 which may belong to different SSIDs, and is used when non-AP MLD 160 may roam from one AP MLD in one SSID to another AP MLD in a different SSID. Once having created the security context for non-AP MLD 160 associated with extended SMD 140 at stage 240, method 200 may terminate at end block 250.

Non-AP MLD 160 may associate with extended SMD 140 or ExSMD-ME 145 as per the procedure defined for IEEE 802.11bn for SMD-ME association. The security context (for example, PMKSA and PTKSA) that may be established for non-AP MLD 160 may be set up per extended SMD 140 and hence may apply across all member AP MLDs that are part of the different SSIDs of extended SMD 140. Non-AP MLD 160 when performing initial authentication and association with extended SMD 140 may associate through one of member AP MLDs of extended SMD 140. The authentication credential that non-AP MLD 160 may use for initial authentication and association may be the credential corresponding to the SSID of a current AP MLD of extended SMD 140 with which non-AP MLD 160 may be performing the authentication and association with extended SMD 140.

In a first example implementation, as part of the initial authentication and association to extended SMD 140, non-AP MLD 160 may perform authentication for each SSID to which member AP MLDs in extended SMD 140 belong to. For example, when extended SMD 140 includes AP MLDs from the SSID1 and the SSID2, then non-AP MLD 160 may perform authentication (using credentials) for both the SSID1 and the SSID2 as part of the initial association to extended SMD 140. Separate security context may be created for each SSID that may be part of extended SMD 140. For example, a separate PMKSA and a separate PTKSA may be created for each SSID as part of initial SMD association. That is, in the first example implementation, for non-AP MLD 160, two sets of PMKSA and PTKSA may get created (one for SSID1 and one for SSID2) as part of the association to extended SMD 140. Then when non-AP MLD 160 may roam within extended SMD 140, based on an SSID to which AP MLD belongs to, it may use corresponding Security Association (SA) for secure communication with the AP MLD of extended SMD 140. For example, if non-AP MLD 160 is communicating with first AP MLD 110 part of the SSID1, then non-AP MLD 160 may use the PMKSA and PTKSA setup for the SSID1.

In another example implementation, a single PMKSA credential may be setup for entire extended SMD 140 (applicable across SSIDs of extended SMD 140) along with different PTKSA credential for each SSID that may be part of extended SMD 140. The PMKSA may be established based on non-AP MLD 160 authentication with extended SMD 140 using the credential of the SSID to which a current AP MLD may belong to. So, when extended SMD 140 may include AP MLDs from the SSID1 and the SSID2, and non-AP MLD 160 associates with first AP MLD 110 (part of SSID1), a single PMKSA may be established at the time of initial SMD association based on non-AP MLD 160 authentication using the SSID1 credential. Additionally, two different PTKSA may be established (for example, a first PTKSA (that is, PTKSA1) for the SSID1 and a second PTKSA (that is, PTKSA2) for SSID2) as part of the initial association with extended SMD 140. Non-AP MLD 160 may use an appropriate PTKSA when connecting with extended SMD 140 based on which SSID a current AP MLD may belong to. A PTKSA may include a PTK or a Transient Key (TK) keying material used for secure frame exchanges between AP MLDs and non-AP MLD 160.

As part of AP MLD's recommendation for seamless roaming candidates, for example, using Basic Service Set (BSS) Transition Management Request (BTM) frame or using another management frame, the recommended candidates may be APs or AP MLDs that are part of different SSIDs but in same extended SMD 140. The SSIDs of recommended APs/AP MLDs may be indicated through an SSID sub-element in a Neighbor Report (NR) element of the BTM frame or by using a SSID sub-element in another management frame recommending candidate APs/AP MLDs for the seamless roaming.

Seamless roaming procedure may be performed between two AP MLDs of extended SMD 140 which are part of different SSIDs using the security context that gets created as part of the initial authentication and association with extended SMD 140. The seamless roaming procedure involves a roaming preparation and then a roaming execution as described above. The Seamless roaming preparation procedure may be performed between AP MLDs that are part of different SSIDs and in same extended SMD 140. This may imply that the context transfer, link setup (in advance), and resource reservation procedure may be performed for a target AP/AP MLD that may be part of another SSID (and within same extended SMD 140) for the seamless roaming preparation. This may also include security association context transfer (that is, PMKSA and PTKSA transfer) to a target AP/AP MLD belonging to another SSID. Further, if a new per-AP PTK is generated for a target AP MLD as part of the seamless roaming preparation, then the new per-AP PTK may also be generated for a target AP MLD that belongs to a different SSID. In this scenario, if a different PMKSA was generated for that SSID as part of the initial association to extended SMD 140 (as described above), then the corresponding PMKSA for that SSID may be used when generating the per-AP PTK (or TK) for the target AP MLD.

That is, non-AP MLD 160 may initiate a request to perform roaming preparation for a target AP MLD that may be part of a different SSID and in the same extended SMD 140 as a current AP MLD. If non-AP MLD 160 is performing roaming directly through a target AP MLD that is part of a different SSID (and same extended SMD 140), then non-AP MLD 160 may use the PTKSA established for that SSID for secure roaming frame exchange with the target AP MLD. Then the seamless roaming execution procedure may be performed between AP MLDs that may be part of different SSIDs and in same extended SMD 140. This may include dynamic context transfer to the target AP MLD that may belong to another SSID and may be part of extended SMD 140 as the current AP MLD.

As discussed above, an AP MLD may signal explicitly, for example, as a part of its SMD capability information (e.g. in the SMD Information element) whether it supports extended SMD 140 across multiple SSIDs/ESSs and the extended SMD security modes supported for such extended SMD 140. The modes may include: a single PMKSA and PTKSA across all SSIDs of extended SMD 140; different PMKSA and different PTKSA for each SSID of extended SMD 140; different PMSA for each SSID of extended SMD 140, same PTKSA across all SSIDs of extended SMD 140; and per-AP PTK (or TK) mode support across all SSIDs or for each SSID. In one example, these different security modes for extended SMD 140 containing multiple SSIDs may be signaled using different Authentication and Key Management (AKM) values.

Non-AP MLD 160 may also signal whether it supports seamless roaming within extended SMD 140 that may include AP MLDs with multiple SSIDs. This may imply that non-AP MLD 160 may support one or more security modes for extended SMD 140 as described above.

Accordingly, the disclosure provides extended SMD 140 that may include AP MLDs from multiple SSIDs/ESSs that may be part of the same management domain and hence may enable seamless roaming between AP MLDs across different SSIDs. This may provide improved roaming experience for non-AP MLD 160 where different SSIDs may be managed by the same management domain.

FIG. 3 shows computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for seamless roaming across AP MLDs in with SSIDs as described above with respect to FIG. 2. Computing device 300, for example, may provide an operating environment for controller 105, first AP MLD 110, second AP MLD 120, third AP MLD 130, SMD 140, SMD ME 145, DS 150, and non-AP MLD 160. Controller 105, first AP MLD 110, second AP MLD 120, third AP MLD 130, extended SMD 140, ExSMD-ME 145, DS 150, and non-AP MLD 160 may operate in other environments and are not limited to computing device 300.

Computing device 300 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Implementations of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, implementations of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a Random Access Memory (RAM), a Read-only Memory (ROM), an Erasable Programmable Read-only Memory (EPROM or Flash memory), an optical fiber, and a portable Compact Disc Read-only Memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain implementations of the disclosure have been described, other implementations may exist. Furthermore, although implementations of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, implementations of the disclosure may be practiced in an electrical circuit comprising discrete electronic elements, packaged or integrated electronic chips containing logic gates, a circuit utilizing a microprocessor, or on a single chip containing electronic elements or microprocessors. Implementations of the disclosure may also be practiced using other technologies capable of performing logical operations such as, for example, AND, OR, and NOT, including but not limited to, mechanical, optical, fluidic, and quantum technologies. In addition, implementations of the disclosure may be practiced within a general purpose computer or in any other circuits or systems.

Implementations of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to implementations of the disclosure, may be performed via application-specific logic integrated with other components of computing device 300 on the single integrated circuit (chip).

Implementations of the present disclosure, for example, are described above with reference to block diagrams and/or operational illustrations of methods, systems, and computer program products according to implementations of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as example for implementations of the disclosure.

What is claimed is:

1. A method comprising:
creating a backhaul network connection between a first Access Point (AP) Multi-Link Device (MLD) having a first Service Set Identifier (SSID) and a second AP MLD having a second SSID; and
forming an extended Seamless Mobility Domain (SMD) comprising the first AP MLD having the first SSID and the second AP MLD having the second SSID, wherein forming the extended SMD comprises enabling the first AP MLD and the second AP MLD to exchange a security context over the backhaul network connection.

2. The method of claim 1, further comprising:
signaling that the extended SMD comprises AP MLDs across multiple SSIDs.

3. The method of claim 1, further comprising:
performing, for a non-AP MLD, authentication for both the first SSID and the second SSID as part of an initial authentication and association with the extended SMD.

4. The method of claim 1, further comprising:
creating a security context for a non-AP MLD associated with the extended SMD.

5. The method of claim 4, wherein creating the security context comprises:
creating a first Pairwise Master Key Security Association (PMKSA) and Pairwise Transient Key Security Association (PTKSA)) for the first SSID; and
creating a second PMKSA and PTKSA for the second SSID.

6. The method of claim 4, wherein creating the security context comprises:
creating a Pairwise Master Key Security Association (PMKSA) for both the first SSID and the second SSID;
creating a first Pairwise Transient Key Security Association (PTKSA)) for the first SSID; and
creating a second PTKSA for the second SSID.

7. The method of claim 4, further comprising:
performing a seamless roaming procedure for the non-AP MLD from the first AP MLD to the second AP MLD using the security context of the non-AP MLD created with the extended SMD.

8. The method of claim 1, further comprising:
providing a recommendation for seamless roaming candidates, wherein the seamless roaming candidates are part of different SSIDs but in the extended SMD.

9. A system comprising:
a memory storage; and
a processing unit coupled to the memory storage, wherein the processing unit is operative to:
create a backhaul network connection between a first Access Point (AP) Multi-Link Device (MLD) having a first Service Set Identifier (SSID) and a second AP MLD having a second SSID; and
form an extended Seamless Mobility Domain (SMD) comprising the first AP MLD having the first SSID and the second AP MLD having the second SSID, wherein the processing unit being operative to form the extended SMD comprises the processing unit being operative to enable the first AP MLD and the second AP MLD to exchange a security context over the backhaul network connection.

10. The system of claim 9, wherein the processing unit is further operative to:
signal that the extended SMD comprises AP MLDs across multiple SSIDs.

11. The system of claim 9, wherein the processing unit is further operative to:
perform, for a non-AP MLD, authentication for both the first SSID and the second SSID as part of an initial SMD association.

12. The system of claim 9, wherein the processing unit is further operative to:
create a security context for a non-AP MLD associated with the extended SMD.

13. The system of claim 12, wherein the processing unit being operative to create the security context comprises the processing unit being operative to:
create a first Pairwise Master Key Security Association (PMKSA) and Pairwise Transient Key Security Association (PTKSA)) for the first SSID; and
create a second PMKSA and PTKSA for the second SSID.

14. The system of claim 12, wherein the processing unit being operative to create the security context comprises the processing unit being operative to:
create a Pairwise Master Key Security Association (PMKSA) for both the first SSID and the second SSID;
create a first Pairwise Transient Key Security Association (PTKSA)) for the first SSID; and
create a second PTKSA for the second SSID.

15. A non-transitory computer readable medium that stores a set of instructions which when executed perform a method executed by the set of instructions comprising:
creating a backhaul network connection between a first Access Point (AP) Multi-Link Device (MLD) having a first Service Set Identifier (SSID) and a second AP MLD having a second SSID; and
forming an extended Seamless Mobility Domain (SMD) comprising the first AP MLD having the first SSID and the second AP MLD having the second SSID, wherein forming the extended SMD comprises enabling the first AP MLD and the second AP MLD to exchange a security context over the backhaul network connection.

16. The non-transitory computer readable medium of claim 15, further comprising:
signaling that the extended SMD comprises AP MLDs across multiple SSIDs.

17. The non-transitory computer-readable medium of claim 15, further comprising:
performing, for a non-AP MLD, authentications for both the first SSID and the second SSID as part of an initial SMD association.

18. The non-transitory computer-readable medium of claim 15, further comprising:
creating a security context for a non-AP MLD associated with the extended SMD.

19. The non-transitory computer-readable medium of claim 18, wherein creating the security context comprises:
creating a first Pairwise Master Key Security Association (PMKSA) and Pairwise Transient Key Security Association (PTKSA)) for the first SSID; and
creating a second PMKSA and PTKSA for the second SSID.

20. The non-transitory computer-readable medium of claim 18, wherein creating the security context comprises:
creating a Pairwise Master Key Security Association (PMKSA) for both the first SSID and the second SSID;
creating a first Pairwise Transient Key Security Association (PTKSA)) for the first SSID; and
creating a second PTKSA for the second SSID.
